(19) United States
(12) Patent Application Publication
(10) Pub. No.: US 2026/0321727 A1
(43) Pub. Date: Oct. 15, 2026

(54) ELECTROCHEMICAL CELLS WITH HIGHLY PERFORMING SOLID ELECTROLYTES

(71) Applicant: Toyota Motor Engineering & Manufacturing North America, Inc., Plano, TX (US)

(72) Inventors: Rana Mohtadi, Northville, MI (US); Jian Pan, Ann Arbor, MI (US); Oscar Tutusaus, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/643,040

(22) Filed: Apr. 9, 2026

Related U.S. Application Data
(63) Continuation-in-part of application No. 19/358,619, filed on Oct. 15, 2025.
Application No. 19/358,619 is a continuation of application No. 17/846,334, filed on Jun. 22, 2022, now Pat. No. 12,469,884.

(51) Int. Cl. H01M 10/0568; H01M 10/052; H01M 10/0562; H01M 10/39

(52) U.S. Cl. CPC H01M 10/0568; H01M 10/052; H01M 10/0562; H01M 10/399; H01M 2300/0048; H01M 2300/0065

(57) ABSTRACT

A boron cluster-based solid state electrolyte includes a composite salt mixture having between 0.975 and 0.05 mole fraction of a halogen-free boron cluster salt, between 0.025 and 0.95 mole fraction of a halogenated boron cluster salt, and an activation energy less than 0.70 eV at one or more temperatures below 30° C. An electrochemical cell includes a cathode, an anode, and the boron cluster-based solid state electrolyte. The electrochemical cell can also include a catholyte, an anolyte, and/or a separator, and the catholyte, the anolyte, and/or the separator can include the boron cluster-based solid state electrolyte.

### CROSS-REFERENCE TO RELATED APPLICATION

This application is a continuation-in-part application of currently pending U.S. patent application Ser. No. 19/358,619, filed on Oct. 15, 2025, which is a continuation application of U.S. patent application Ser. No. 17/846,334, filed on Jun. 22, 2022, both of which are incorporated herein in their entirety by reference.

### TECHNICAL FIELD

The present disclosure generally relates to electrochemical cells, and particularly to electrochemical cells with highly reactive battery anodes.

### BACKGROUND

Solid-state electrolytes provide many advantages in secondary battery design, including mechanical stability, no volatility, and ease of construction. Typical inorganic solid-state electrolytes having high ionic conductivity are sulfides-based electrolytes. For example, Zhang et al. reported that the ionic conductivity for a sulfide electrolyte can exceed 25 mS/cm, which is advantageous for battery applications (Zhang Z et al. Energy Environ. Sci., 2018, 11, 1945). However, sulfide-based electrolytes suffer from the high propensity to form H₂S toxic gases upon exposure to a low level of moisture, which challenges their practical use. Other classes such as polymeric and other organic have inferior ionic mobility at technologically relevant temperatures below 60° C.

The present disclosure addresses these issues with solid-state electrolytes, and other issues related to electrolytes.

### SUMMARY

In one form of the present disclosure, an electrolyte includes: a composite salt mixture comprising between 0.975 and 0.05 mole fraction of a halogen-free boron cluster salt, between 0.025 and 0.95 mole fraction of a halogenated boron cluster salt, and an activation energy less than 0.70 eV at one or more temperatures below 30° C.

In another form of the present disclosure, an electrochemical cell includes: a cathode selected from the group consisting of an insertion cathode and a conversion cathode, and an organic cathode; an anode selected from the group consisting of an intercalation anode, a metal anode, an alloy anode, and an organic anode; and a boron cluster-based solid-state electrolyte comprising: a metal cation selected from the group consisting of Li⁺, Na⁺, K⁺, Mg²⁺, Ca²⁺, Zn²⁺, Al³⁺, and any combination thereof, and a composite salt mixture comprising between 0.975 and 0.05 mole fraction of a halogen-free boron cluster salt, between 0.025 and 0.95 mole fraction of a halogenated boron cluster salt, and an activation energy less than 0.70 eV at one or more temperatures below 30° C.

These and other features of the nearly solvent-free combined salt electrolyte and its preparation will become apparent from the following detailed description when read in conjunction with the figures and examples, which are exemplary, not limiting.

### BRIEF DESCRIPTION OF THE DRAWINGS

The present teachings will become more fully understood from the detailed description and the accompanying drawings, wherein:

FIG. 1 is an Arrhenius plot of cationic conductivity versus temperature for a halogen-free boron cluster salt, and a composite salt mixture of the halogen-free boron cluster salt and a halogenated boron cluster salt according to the teachings of the present disclosure;

FIG. 2 is an Arrhenius plot of cationic conductivity versus temperature for a halogen-free boron cluster salt, and another composite salt mixture of the halogen-free boron cluster salt and the halogenated boron cluster salt according to the teachings of the present disclosure;

FIG. 3 is a plot of cationic conductivity and activation energy versus % molar content of the halogenated boron cluster salt LiCB₁₁H₁₁F in a LiCB₁₁H₁₂— LiCB₁₁H₁₁F composite salt mixture;

FIG. 4 shows an electrochemical device according to the teachings of the present disclosure;

FIG. 5 is an Arrhenius plot of cationic conductivity versus temperature for a composite salt mixture of a LiCB₁₁H₁₂—50 mol % LiCB₁₁H₁₁F composition according to the teachings of the present disclosure;

FIG. 6 is an Arrhenius plot of cationic conductivity versus temperature for a composite salt mixture of a LiCB₁₁H₁₂—60 mol % LiCB₁₁H₁₁F composition according to the teachings of the present disclosure; and

FIG. 7 is an Arrhenius plot of cationic conductivity versus temperature for a composite salt mixture of a LiCB₁₁H₁₂—70 mol % LiCB₁₁H₁₁F composition according to the teachings of the present disclosure.

It should be noted that the figures set forth herein are intended to exemplify the general characteristics of the methods, algorithms, and devices among those of the present technology, for the purpose of the description of certain aspects. The figures may not precisely reflect the characteristics of any given aspect and are not necessarily intended to define or limit specific forms or variations within the scope of this technology.

### DETAILED DESCRIPTION

In an effort to overcome the issues related to sulfide-based electrolytes noted above, polymeric electrolytes and other organic electrolytes have been studied but found to exhibit inferior ionic mobility at technologically relevant temperatures below 60° C. And recently, boron cluster salts have been reported to possibly form superionic conductors at above 50° C., and for many of these salts at above 120° C. In some instances, these superconductor high temperature phases can be stabilized at room temperature for limited boron cluster salts (e.g., see U.S. Pat. No. 10,553,897; Kim S. et al. Nature Communications 10:1081, 2019; Tang W. S. et al. ACS Energy Lett. 2016, 1, 659-664). However, such an approach is problematic as the ionic conduction property, which includes the activation energy, is dictated by the intrinsic property and structural features of the high temperature phases. In fact, salts of boron clusters, and also most polymeric and other solid-state inorganic electrolytes, generally exhibit relatively high activation energies for cationic mobility at temperatures below 60° C., which in turn implies a strong effect of the temperature on cationic mobility—a property not desired for device operation. For example, the lowest activation energy for a room temperature superionic boron cluster lithium cation conductor has been reported to be greater than 0.29 eV (Kim S. et al., Nature Communications 10:1081, 2019). And the activation energy for carborane-type Li boron cluster salts exceeded 0.31 eV for temperatures above 39° C. and increased to 0.74 eV as these electrolytes were cooled below 39° C. (Tang W. S. et al. ACS Energy Lett. 2016, 1, 659-664).

In contrast to previous teachings, the present disclosure provides electrolytes with low activation energies (i.e., less than 0.28 eV) that include a composite salt mixture in which at least two different salts are in direct contact with each other. The composite salt mixture includes a combination of a halogen-free boron cluster salt and a halogenated boron cluster salt (also referred to herein simply as “combined halogen-free boron cluster/halogenated boron cluster salt”) and the combined halogen-free boron cluster/halogenated boron cluster salt provides an inorganic boron cluster solid state electrolyte with a cationic conductivity that is at least one order of magnitude greater than a cationic conductivity of the halogen-free boron cluster salt, at least one order of magnitude greater than a cationic conductivity of the halogenated boron cluster salt, and low activation energies at room temperature (i.e., 20-22° C.). In addition, electrolytes according to the teachings of the present disclosure can exhibit and/or maintain relatively low activation energies even after cooling to sub-ambient temperatures.

In some variations of the present disclosure, the halogen-free boron cluster salt includes a cation selected from Li⁺, Na⁺, K⁺, Mg²⁺, Ca²⁺, Zn²⁺, and Al³⁺, and a boron cluster anion with the structure [B_{y}H_{(y-z)}R_{z}]²⁻, [CB_{(y-1)}H_{(y-z)}R_{z}]⁻, [C₂B_{(y-2)}H_{(y-t-1)}Rₜ]⁻, [C₂B_{(y-3)}H_{(y-t)}Rₜ]⁻, or [C₂B_{(y-3)}H_{(y-t-1)}Rₜ]²⁻, and where y is an integer within a range of 6 to 12, (z) is an integer within a range of 0 to y, (t) is an integer within a range of 0 to (y−1), and R is a linear, branched-chain, or cyclic C1-C18 alkyl or fluoroalkyl group. And in at least one variation, the halogenated boron cluster salt includes a cation selected from Li⁺, Na⁺, K⁺, Mg²⁺, Ca²⁺, Zn²⁺, and Al³⁺, and a boron cluster anion with the structure [B_{y}H_{(y-z-i)}R_{z}Xᵢ]²⁻, [CB_{(y-1)}H_{(y-z-i)}R_{z}Xᵢ]⁻, [C₂B_{(y-2)}H_{(y-t-j-1)}RₜXⱼ]⁻, [C₂B_{(y-3)}H_{(y-t-j)}RₜXⱼ]⁻, or [C₂B_{(y-3)}H_{(y-t-j-1)}RₜXⱼ]²⁻, and where y is an integer within a range of 6 to 12, (z+i) is an integer within a range of 0 to y, (t+j) is an integer within a range of 0 to (y−1), X is F, Cl, Br, I, or a combination thereof, and R is a linear, branched-chain, or cyclic C1-C18 alkyl or fluoroalkyl group. In the alternative, X is a halogenated alkyl group containing CF₃. For example, in some variations the boron cluster anion of the halogen-free boron cluster salt and/or the halogenated boron cluster salt is B₁₂H₁₂⁻², B₁₀H₁₀⁻², CB₁₁H₁₂⁻¹ or CB₉H₁₀⁻¹, or a substituted derivative thereof. It should be understood that the large sizes of the boron clusters anions, such as B₁₂H₁₂⁻², B₁₀H₁₀⁻², CB₁₁H₁₂⁻¹, and CB₉H₁₀⁻¹, are attractive for solid-state batteries since such anions display orientation mobility and a dynamic frustration that allows order-disorder phase transitions, which in turn leads to high cation mobility for enhanced ion conduction.

A cation of the halogen-free boron cluster salt can be the same or different than a cation of the halogenated boron cluster salt. Accordingly, an electrolyte formulation with the composite salt mixture can include multiple different boron cluster anions and multiple different cations. The mole percentage (mol %) of the Li⁺, Na⁺, K+, Mg2+, Ca2+, Zn2+, and Al3+ cation(s) of the total cations in the electrolyte can be from about 1 to about 100 percent and the mole percentage of boron cluster anions of all anions of the electrolyte can be from about 0.5 to about 100 percent.

In some variations, an electrolyte with the composite salt mixture can include one or more additional cation conductivity enhancing anions. A mole fraction of the one or more additional conductivity enhancing anion to the total anions in the composite salt mixture can be from about 0.01 to about 0.9. Also, the one or more additional conductivity enhancing anions can be selected from F⁻, Cl⁻, Br⁻, I⁻, RₓBF₄₋ₓ⁻, R_{y}PF_{6-y}⁻, SbF₆⁻, ClO₄⁻, SO₄⁻², N(SO₂F)₂⁻, N(SO₂(CF₂)ₙCF₃)₂⁻, [NSO₂(CF₂)ₙ₊₁SO₂]⁻, or CF₃(CF₂)ₙSO₃⁻, where: n is 0 to 5; x is 0 to 4; y is 0 to 6; and R is a linear, branched, or cyclic alkyl group that can be unsubstituted, partially fluorinated, or fully fluorinated.

In at least one variation, an electrolyte is formulated from the combined halogen-free boron cluster/halogenated boron cluster salt with an addition of an organic plastic crystal such that a soft solid electrolyte with appreciable cation conductivity(ies) is provided. The organic plastic crystal material can be a succinonitrile-glutaronitrile mixture where the mole percent of glutaronitrile is 15 to 96 mole % and the plastic state (i.e., the organic plastic crystal) promotes cation conductivities of more than 10⁻⁷ S/cm at 60° C. And in some variations, the electrolyte includes the combined halogen-free boron cluster/halogenated boron cluster salt, the organic plastic crystal, and the one or more additional cation conductivity enhancing anions.

In one form of the present disclosure, the combined halogen-free boron cluster/halogenated boron cluster salt is included in a solid-state electrolyte for a solid-state electrochemical device. In another form of the present disclosure, an electrolyte with the combined halogen-free boron cluster/halogenated boron cluster salt is in a partially liquid molten state at room temperature (i.e., 20-25° C.). And in still another form, an electrolyte with the combined halogen-free boron cluster/halogenated boron cluster salt is in a fully liquid molten state at room temperature.

In some variations, a combined halogen-free boron cluster/halogenated boron cluster salt is prepared by combining or mixing appropriate amounts of a halogen-free boron cluster salt and a halogenated boron cluster salt using mechanochemical synthetic ball milling followed by an optional heat treatment of the ball-milled material at temperatures less than 200° C. and an optional ball milling homogenization step. In other variations, a combined halogen-free boron cluster/halogenated boron cluster salt is prepared using solution-based synthesis in which appropriate amounts of a halogen-free boron cluster salt and a halogenated boron cluster salt are dissolved in a solvent (e.g., an ether solvent) followed by a solvent removal step and an optional ball milling homogenization step.

In some variations, an electrochemical device that includes an anode, a cathode, and an electrolyte with the combined halogen-free boron cluster/halogenated boron cluster salt in contact with the anode and the cathode is provided in the present disclosure. The electrochemical device can be a secondary battery or a subunit of a secondary battery. The anode is an electrode where alkali metal or alkali earth metal oxidation occurs during the device's discharge and where reduction occurs during the device's charge. Similarly, the cathode is an electrode where a cathode material reduction occurs during the device's discharge and a cathode material oxidation occurs during the device's charge.

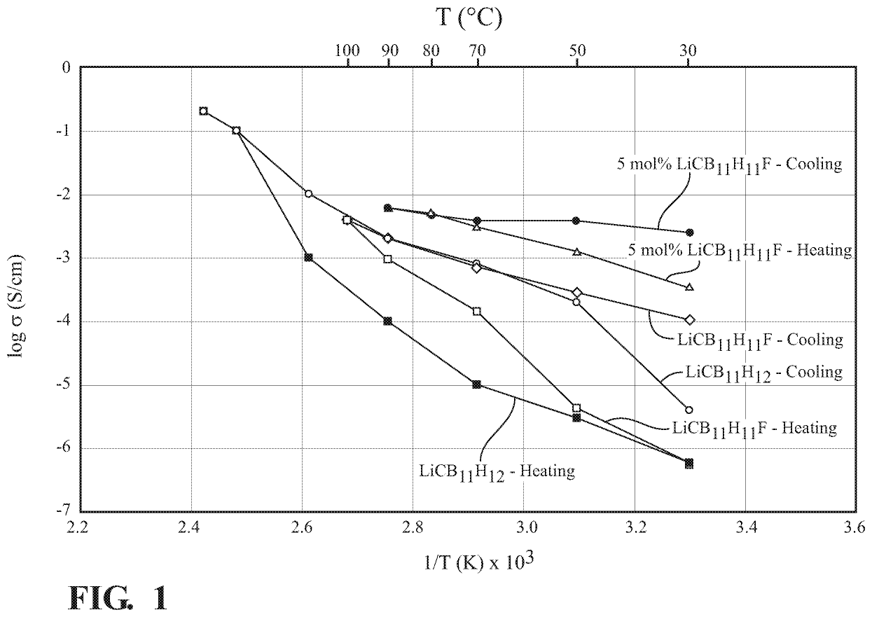

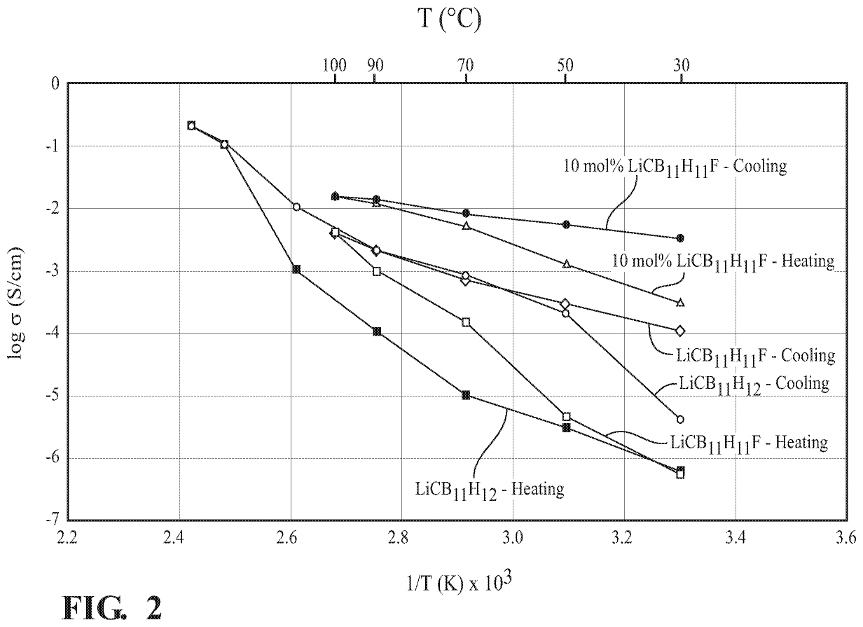

Referring now to FIGS. 1 and 2, Arrhenius plots of conductivity versus temperature for two combined halogen-free boron cluster/halogenated boron cluster salts according to the teachings of the present disclosure are shown. Particularly, FIG. 1 shows an Arrhenius plot for a combined 95 mol % LiCB₁₁H₁₂—5 mol % LiCB₁₁H₁₁F salt subjected to cationic conductivity measurements at 30, 50, 70, 80, and 90° C. during heating of the combined 95 mol % LiCB₁H₁₂ —5 mol % LiCB₁₁H₁₁F salt (labeled “5 mol % LiCB₁₁H₁₁F—Heating”) and cationic conductivity measurements at 90, 80, 70, 50, and 30° C. following the heating of the combined 95 mol % LiCB₁₁H₁₂—5 mol % LiCB₁₁H₁₁F salt (labeled “5 mol % LiCB₁₁H₁₁F—Cooling”). FIG. 2 shows an Arrhenius plot for a combined 90 mol % LiCB₁₁H₁₂—10 mol % LiCB₁₁H₁₁F salt subjected to cationic conductivity measurements at 30, 50, 70, 90, and 100° C. during heating (labeled “10 mol % LiCB₁₁H₁₁F—Heating”) and cationic conductivity measurements at 100, 90, 70, 50, and 30° C. following the heating of the combined 90 mol % LiCB₁₁H₁₂—10 mol % LiCB₁₁H₁₁F salt (labeled “10 mol % LiCB₁₁H₁₁F—Cooling”). And for comparison, FIGS. 1 and 2 also show cationic conductivities for neat LiCB₁₁H₁₂ during heating.

The combined 95 mol % LiCB₁₁H₁₂—5 mol % LiCB₁₁H₁₁F salt and the combined 90 mol % LiCB₁₁H₁₂—10 mol % LiCB₁₁H₁₁F salt were prepared by mixing LiCB₁₁H₁₂ and LiCB₁₁H₁₁F salts with a mortar and pestle, followed by ball milling at 700 revolutions per minute (RPM) for 24 hours to ensure uniformity of the combined LiCB₁₁H₁₂—LiCB₁₁H₁₁F salts. A solid-state electrolyte pellet for each of the combined LiCB₁₁H₁₂—LiCB₁₁H₁₁F salts was formed by pressing a given LiCB₁₁H₁₂—LiCB₁₁H₁₁F salt mixture under at least 120 MPa of pressure. Also, carbon-coated aluminum foil was used as the working electrode and the counter electrode of a two-electrode cell, and a solid-state electrolyte pellet of the combined 95 mol % LiCB₁₁H₁₂—5 mol % LiCB₁₁H₁₁F salt or the combined 90 mol % LiCB₁₁H₁₂—10 mol % LiCB₁₁H₁₁F salt was in direct contact with the working and counter electrodes during cationic conductivity measurements.

Referring particularly to FIG. 1, the combined 95 mol % LiCB₁₁H₁₂—5 mol % LiCB₁₁H₁₁F salt exhibited cationic conductivities of about 3.6×10⁻⁴ S/cm at 30° C. initially and of about 2.2×10⁻³ S/cm at 30° C. after heating. In contrast, the neat LiCB₁₁H₁₂ salt exhibited cationic conductivities initially of about 6.0×10⁻⁷ S/cm at 30° C. and about 4.0×10⁻⁶ S/cm at 30° C. after heating. Accordingly, an increase in cationic conductivity of the combined 95 mol % LiCB₁₁H₁₂—5 mol % LiCB₁₁H₁₁F salt after heat treatment and an extremely low activation energy of 0.209 eV, and the cationic conductivity of the combined 95 mol % LiCB₁₁H₁₂—5 mol % LiCB₁₁H₁₁F salt at 30° C. was greater than about 500 to 1000 times the cationic conductivity of the LiCB₁₁H₁₂.

Referring particularly to FIG. 2, the combined 90 mol % LiCB₁₁H₁₂—10 mol % LiCB₁₁H₁₁F salt exhibited cationic conductivities initially of about 3.2×10⁻⁴ S/cm at 30° C. and about 3.2×10⁻³ S/cm at 30° C. following the heating cycle. In contrast, and as noted above, the neat LiCB₁₁H₁₂ salt exhibited cationic conductivities of about 6.0×10⁻⁷ S/cm at 30° C. and about 4.0×10⁻⁶ S/cm at 30° C. following the heating cycle. Accordingly, an increase in cationic conductivity of the combined 90 mol % LiCB₁₁H₁₂—10 mol % LiCB₁₁H₁₁F salt was observed as was an extremely low activation energy of less than 0.3 eV, and the cationic conductivity of the combined 90 mol % LiCB₁₁H₁₂—10 mol % LiCB₁₁H₁₁F salt at 30° C. was greater than about 500 to 1000 times the cationic conductivity of the LiCB₁₁H₁₂.

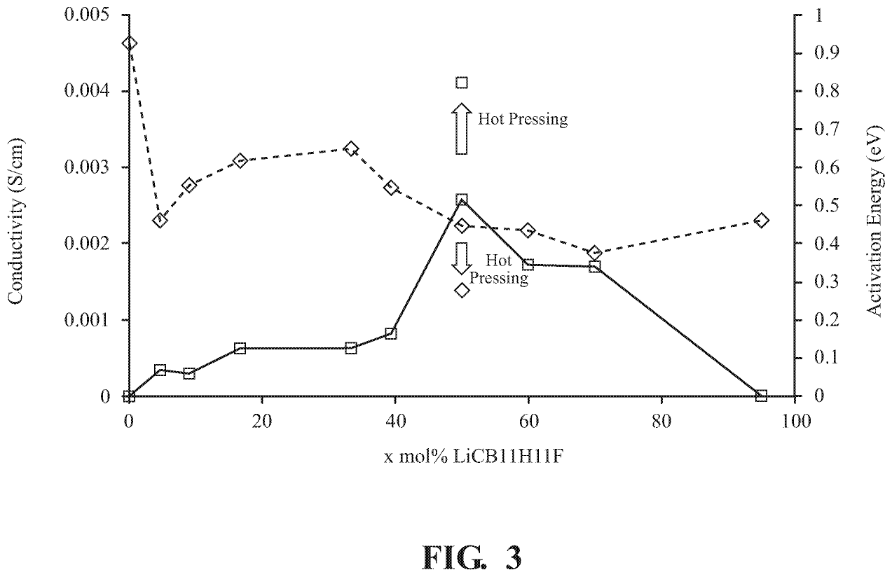

Referring now to FIG. 3, a plot of conductivity at 30° C. (solid line) and activation energy (dashed line) calculated from the temperature range 30-60° C. for a plurality LiCB₁₁H₁₂—LiCB₁₁H₁₁F compositions is shown. The compositions were cold pressed and not subjected to thermal activation, except for the two data points shown for a 50 mol % LiCB₁₁H₁₂—50 mol % LiCB₁₁H₁₁F composition. And as observed from FIG. 3, the conductivity of 100 mol % LiCB₁₁H₁₂ and 5 mol % LiCB₁₁H₁₂—95 mol % LiCB₁₁H₁₁F (solid line) is very low compared to desired compositions of LiCB₁₁H₁₂ and LiCB₁₁H₁₁F. For example, compositions such as 50 mol % LiCB₁₁H₁₂—50 mol % LiCB₁₁H₁₁F can be greater than 1000 times that of 100 mol % LiCB₁₁H₁₂ and greater than 1000 times that of 100 mol % LiCB₁₁H₁₁F. In addition, the plot of conductivity versus composition illustrated a specific range or “sweet spot” of compositions that provide enhanced conductivity at 30° C. In some variations the range of compositions that provide enhanced conductivity is between about 60 mol % LiCB₁₁H₁₂—40 mol % LiCB₁₁H₁₁F and about 20 mol % LiCB₁₁H₁₂—80 mol % LiCB₁₁H₁₁F, while in other variations the range is between about 55 mol % LiCB₁₁H₁₂—45 mol % LiCB₁₁H₁₁F and about 25 mol % LiCB₁₁H₁₂—75 mol % LiCB₁₁H₁₁F. And in at least one variation the range of compositions that provide enhanced conductivity is between about 55 mol % LiCB₁₁H₁₂—45 mol % LiCB₁₁H₁₁F and about 30 mol % LiCB₁₁H₁₂—70 mol % LiCB₁₁H₁₁F. In addition, the 50 mol % LiCB₁₁H₁₂—50 mol % LiCB₁₁H₁₁F composition was further hot pressed and this hot-pressed composition exhibited an even higher conductivity (almost two times greater) compared to the 50 mol % LiCB₁₁H₁₂ —50 mol % LiCB₁₁H₁₁F composition without hot pressing.

Still referring to FIG. 3, and regarding the activation energy for the plurality LiCB₁₁H₁₂—LiCB₁₁H₁₁F compositions (dashed line), all of the tested LiCB₁₁H₁₂—LiCB₁₁H₁₁F compositions that included LiCB₁₁H₁₁F exhibited an activation energy less than 0.65 eV at 30° C. In some variations (i.e., for some compositions), the activation energy was less than 0.61 EV, while in other variations the activation energy was less than 0.58 eV. In at least one variation, the activation energy was less than 0.51 eV, and in some variations the activation energy was less than 0.47 eV, for example, less than 0.42 eV and less than 0.40 eV. And for the LiCB₁₁H₁₂—50 mol % LiCB₁₁H₁₁F composition that was further hot pressed, this sample exhibited an activation energy less than 0.33 eV.

Accordingly, it should be understood that a simple or random combination of a halogen-free boron cluster salt and a halogenated boron cluster salt does not inherently provide a combined halogen-free boron cluster—halogenated boron cluster salt according to the teachings of the present disclosure. Stated differently, a specific range of compositions according to the teachings of the present disclosure provide a composite salt with enhanced conductivity and low activation energy.

It should also be understood from FIGS. 1, 2, and 3 that the combined halogen-free boron cluster—halogenated boron cluster salts according to the teachings of the present disclosure have or exhibit a cationic conductivity that is at least one order of magnitude greater than a cationic conductivity of the halogen-free boron cluster salt and/or at least one order of magnitude greater than a cationic conductivity of the halogenated boron cluster salt. In some variations, the combined halogen-free boron cluster—halogenated boron cluster salts according to the teachings of the present disclosure have or exhibit a cationic conductivity that is at least two orders of magnitude greater than the cationic conductivity of the halogen-free boron cluster salt and/or at least two orders of magnitude greater than the cationic conductivity of the halogenated boron cluster salt. And in at least one variation, the combined halogen-free boron cluster—halogenated boron cluster salts according to the teachings of the present disclosure have or exhibit a cationic conductivity that is between two and three orders of magnitude greater than the cationic conductivity of the halogen-free boron cluster salt and/or between two and three orders of magnitude greater than the cationic conductivity of the halogenated boron cluster salt, and an activation energy less than 0.65 eV, e.g., less than 0.55 eV, less than 0.45 eV, and/or less than 0.35 eV.

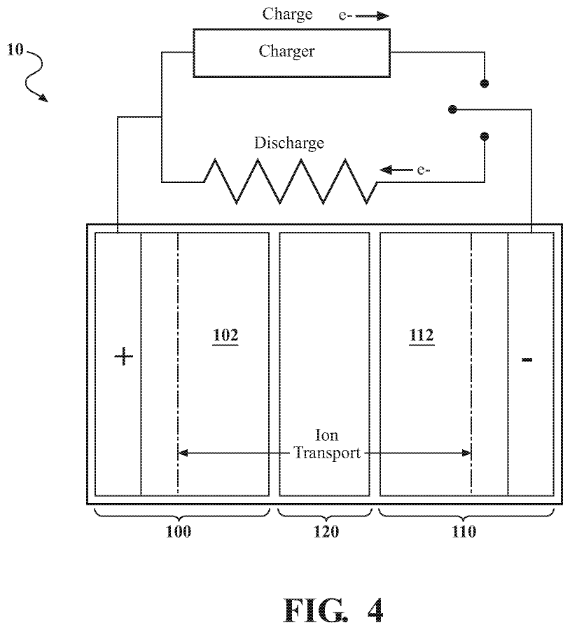

Referring to FIG. 4, an electrochemical device 10 according to the teachings of the present disclosure is shown. In some variations, the electrochemical device 10 is a solid-state electrolyte (SSE) electrochemical device that includes a cathode 100, with or without a catholyte 102, an anode 110, with or without an anolyte 112, and a cell separator (also referred to herein simply as a “separator”) 120. It should be understood that the separator 120 electrically isolates the cathode 100 from the anode 110, but allows ionic conduction therebetween. In some variations, the separator 120 functions as both a ‘separator” between the cathode 100 and the anode 110, and as a solid-state electrolyte for the electrochemical device 10. In other variations, a solid-state electrolyte can be present between the cathode 100 and the anode 110, in addition to the separator 120.

The cathode 100 can be an insertion cathode, a conversion cathode, or an organic cathode, and the anode 110 can be an intercalation anode, a metal anode, an alloy anode, or an organic anode. The electrochemical device 10 includes the inorganic boron cluster solid-state electrolyte according to the teachings of the present disclosure, which includes a metal cation selected from Li⁺, Na⁺, K⁺, Mg²⁺, Ca²⁺, Zn²⁺, and Al³⁺, and the combined halogen-free boron cluster/halogenated boron cluster salt mixture discussed above and disclosed herein.

In some variations, the inorganic boron cluster solid-state electrolyte as disclosed herein is used as the separator 120, is present in the catholyte 102, and/or is present in the anolyte 112 of the electrochemical device 10. As used herein, the term “catholyte” refers to a solid-state electrolyte blended in a cathode to enable and/or enhance cationic diffusion in the cathode electrode structure, and the term “anolyte” refers to a solid-state electrolyte blended in an anode to enable and/or enhance cationic diffusion in the anode electrode structure.

In at least one variation, the separator 120 is not formed from the inorganic boron cluster solid-state electrolyte as disclosed herein. Non-limiting examples of such electrolytes include sulfide solid-state electrolytes, hydride solid-state electrolytes, polymer solid-state electrolytes, oxide solid-state electrolytes, halide-type solid-state electrolytes, plastic crystal solid-state electrolytes, inorganic-organic crystal plastic solid-state electrolytes, and combinations thereof.

In some variations, the catholyte 102 can be formed only from the inorganic boron cluster solid-state electrolyte as disclosed herein, or in the alternative, the catholyte 102 can include the inorganic boron cluster solid-state electrolyte as disclosed herein in combination with another solid-state electrolyte, that is not an inorganic boron cluster-based electrolyte, such as sulfide solid-state electrolytes, hydride solid-state electrolytes, polymer solid-state electrolytes, oxide solid-state electrolytes, halide-type solid-state electrolytes, plastic crystal solid-state electrolytes, inorganic-organic plastic crystal solid-state electrolytes, and combinations thereof.

Similarly, the anolyte 112 can be formed only from the inorganic boron cluster solid state electrolyte as disclosed herein, or in the alternative the anolyte 112 can include the inorganic boron cluster solid state electrolyte as disclosed herein in combination with other solid state electrolytes, that are not an inorganic boron cluster based electrolytes disclosed herein, such as sulfide solid state electrolytes, hydride solid state electrolytes, polymer solid state electrolytes, oxide solid state electrolytes, halide-type solid state electrolytes, plastic crystal solid state electrolytes, inorganic-organic plastic crystal solid state electrolytes, and combinations thereof.

The inorganic boron cluster solid state electrolyte in the electrochemical device 10 exhibits high compatibility with the anode 110, including metallic anodes such as Li, Na, K, Mg, Ca, Zn and Al, alloy anodes such as Si and Sn alloy anodes, conversion anodes, organic anodes and intercalation anodes such as graphite anodes. For example, the inorganic boron cluster solid state electrolyte supports a cycling coulombic efficiency (CE) greater than 90% with the above noted anodes. The inorganic boron cluster solid state electrolyte also exhibits high compatibility with the cathodes noted above, e.g., a conversion cathode such as a sulfur cathode.

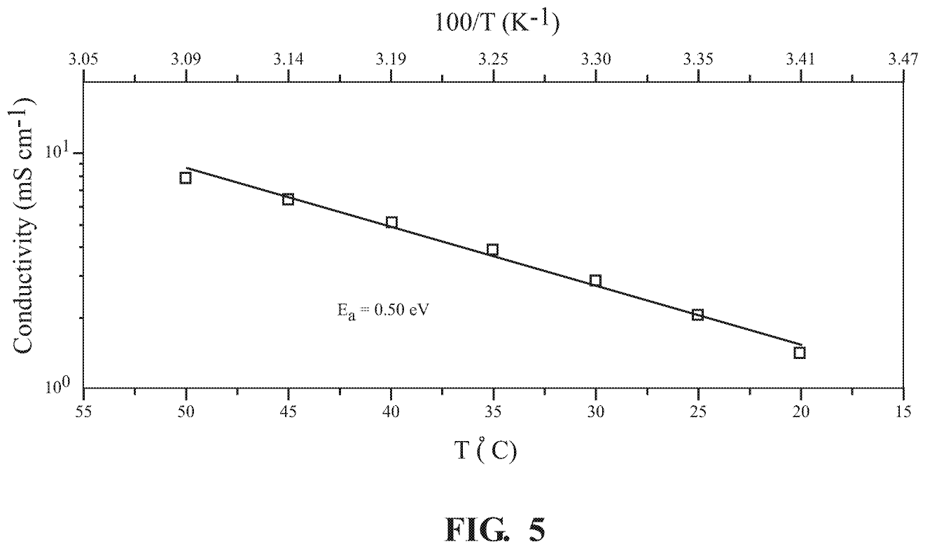

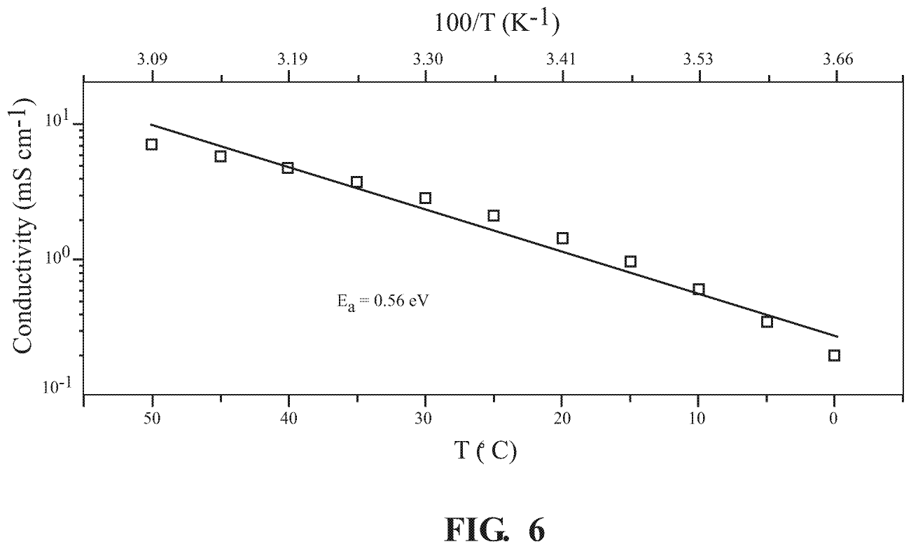

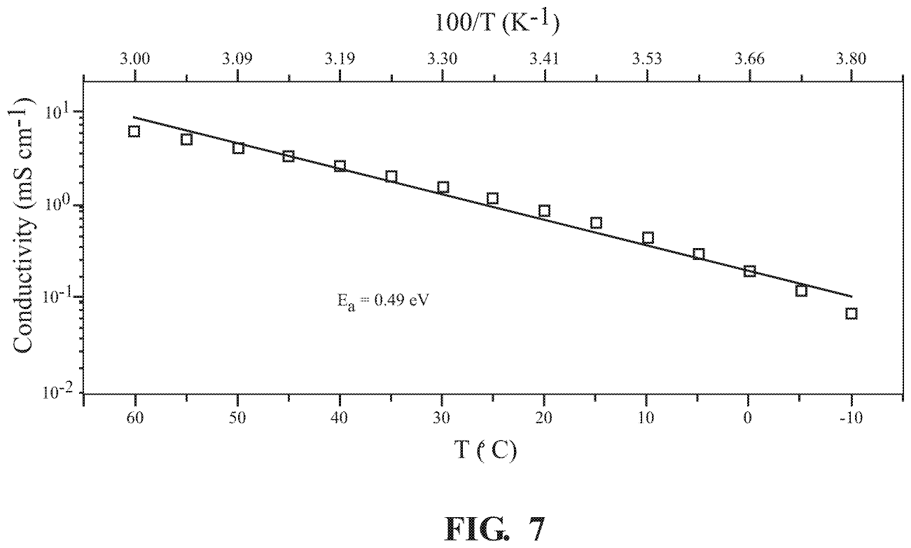

Referring now to FIGS. 5-7, a plot of conductivity and activation energy at various temperatures are shown for a plurality of LiCB₁₁H₁₂—LiCB₁₁H₁₁F compositions. FIG. 5 is an Arrhenius plot of cationic conductivity versus temperature for a composite salt mixture of a LiCB₁₁H₁₂—50 mol % LiCB₁₁H₁₁F composition according to the teachings of the present disclosure. FIG. 6 is an Arrhenius plot of cationic conductivity versus temperature for a composite salt mixture of a LiCB₁₁H₁₂—60 mol % LiCB₁₁H₁₁F composition according to the teachings of the present disclosure. FIG. 7 is an Arrhenius plot of cationic conductivity versus temperature for a composite salt mixture of a LiCB₁₁H₁₂ —70 mol % LiCB₁₁H₁₁F composition according to the teachings of the present disclosure.

The compositions were cold pressed and not subjected to thermal activation. Referring to FIGS. 5-7, the activation energies for the various LiCB₁₁H₁₂—LiCB₁₁H₁₁F compositions with 50 to 70 mol % LiCB₁₁H₁₁F were less than 0.70 eV at one or more temperatures below 30° C. In some variations (i.e., for some compositions), the activation energy was less than 0.61 eV, while in other variations the activation energy was less than 0.58 eV. In at least one variation the activation energy was less than 0.56 eV, and in some variations the activation energy was less than 0.54 eV, for example, less than 0.51 eV and less than 0.50 eV.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple forms or variations having stated features is not intended to exclude other forms or variations having additional features, or other forms or variations incorporating different combinations of the stated features.

As used herein the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with a form or variation is included in at least one form or variation. The appearances of the phrase “in one variation” or “in one form” (or variations thereof) are not necessarily referring to the same form or variation. It should be also understood that the various method steps discussed herein do not have to be carried out in the same order as depicted, and not each method step is required in each form or variation.

The foregoing description of the forms or variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

While particular forms or variations have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

What is claimed is:

1. An electrolyte comprising:
a composite salt mixture comprising between 0.975 and 0.05 mole fraction of a halogen-free boron cluster salt, between 0.025 and 0.95 mole fraction of a halogenated boron cluster salt, and an activation energy less than 0.70 eV at one or more temperatures below 30° C.

2. The electrolyte according to claim 1, wherein the composite salt mixture comprises a cationic conductivity that is at least one order of magnitude greater than a cationic conductivity of the halogen-free boron cluster salt and a cationic conductivity of the halogenated boron cluster salt at temperatures below 150° C.

3. The electrolyte according to claim 1, wherein the halogen-free boron cluster salt comprises a first cation selected from the group consisting of Li⁺, Na⁺, K⁺, Mg²⁺, Ca²⁺, Zn²⁺, and Al³⁺, and the halogenated boron cluster salt comprises a second cation selected from the group consisting of Li⁺, Na⁺, K⁺, Mg²⁺, Ca²⁺, Zn²⁺, and Al³⁺.

4. The electrolyte according to claim 3, wherein:
the halogen-free boron cluster salt comprises:
a Li⁺ cation and a boron cluster anion having a structure selected from the group consisting of:
[B_{y}H_{(y-z)}R_{z}]²⁻, [CB_{(y-1)}H_{(y-z)}R_{z}]⁻, [C₂B_{(y-2)}H_{(y-t-1)}Rₜ]⁻, [C₂B_{(y-3)}H_{(y-t)}Rₜ]⁻, and [C₂B_{(y-3)}H_{(y-t-1)}Rₜ]²⁻, and wherein:
y is an integer within a range of 6 to 12;
(z) is an integer within a range of 0 to y;
(t) is an integer within a range of 0 to (y−1); and
R is a linear, branched-chain, or cyclic C1-C18 alkyl or fluoroalkyl group; and
the halogenated boron cluster salt comprises:
a Li⁺ cation and a halogenated boron cluster anion having the structure selected from the group consisting of:
[B_{y}H_{(y-z-1)}R_{z}Xᵢ]²⁻, [CB_{(y-1)}H_{(y-z-1)}R_{z}Xᵢ]⁻, [C₂B_{(y-2)}H_{(y-t-j-1)}RₜXⱼ]²⁻, [C₂B_{(y-3)}H_{(y-t-j)}RₜXⱼ]⁻, and [C₂B_{(y-3)}H_{(y-t-j-1)}RₜXⱼ]²⁻, and wherein:
y is an integer within a range of 6 to 12;
(z+i) is an integer within a range of 0 to y;
(t+j) is an integer within a range of 0 to (y−1);
X is F, Cl, Br, I, a halogenated alkyl group including CF₃, or a combination thereof, and
R is a linear, branched-chain, or cyclic C1-C18 alkyl or fluoroalkyl group.

5. The electrolyte according to claim 4, wherein the composite salt mixture comprises a cationic conductivity that is at least one order of magnitude greater than a cationic conductivity of the halogen-free boron cluster salt and a cationic conductivity of the halogenated boron cluster salt below 30° C., and wherein the composite salt mixture comprises an activation energy less than 0.70 eV below 30° C.

6. The electrolyte according to claim 1, wherein the composite salt mixture comprises between 0.30 and 0.50 mole fraction of a halogen-free boron cluster salt, between 0.50 and 0.70 mole fraction of a halogenated boron cluster salt, and an activation energy less than 0.60 eV at one or more temperatures below 30° C.

7. The electrolyte according to claim 6, wherein the cationic conductivity of the composite salt mixture is at least two orders of magnitude greater than the cationic conductivity of the halogen-free boron cluster salt and the cationic conductivity of the halogenated boron cluster salt at temperatures below 150° C.

8. An electrochemical cell comprising:
a cathode selected from the group consisting of an insertion cathode and a conversion cathode, and an organic cathode;
an anode selected from the group consisting of an intercalation anode, a metal anode, an alloy anode, and an organic anode; and
a boron cluster-based solid state electrolyte comprising:
a metal cation selected from the group consisting of Li⁺, Na⁺, K⁺, Mg²⁺, Ca²⁺, Zn²⁺, Al³⁺, and any combination thereof, and
a composite salt mixture comprising between 0.975 and 0.05 mole fraction of a halogen-free boron cluster salt, between 0.025 and 0.95 mole fraction of a halogenated boron cluster salt, and an activation energy less than 0.70 eV at one or more temperatures below 30° C.

9. The electrochemical cell according to claim 8, further comprising a catholyte, an anolyte, and/or a separator.

10. The electrochemical cell according to claim 9, further comprising the catholyte comprising the boron cluster-based solid state electrolyte.

11. The electrochemical cell according to claim 10, wherein the catholyte further comprises another solid state electrolyte that is not a boron cluster-based solid state electrolyte.

12. The electrochemical cell according to claim 9, further comprising the anolyte comprising the boron cluster-based solid state electrolyte.

13. The electrochemical cell according to claim 12, wherein the anolyte further comprises another solid state electrolyte that is not a boron cluster-based solid state electrolyte.

14. The electrochemical cell according to claim 9, further comprising the catholyte comprising the boron cluster-based solid state electrolyte and the anolyte comprising the boron cluster-based solid state electrolyte.

15. The electrochemical cell according to claim 9, further comprising the separator comprising the boron cluster-based solid state electrolyte.

16. The electrochemical cell according to claim 15, wherein the separator further comprises another solid state electrolyte that is not a boron cluster-based solid state electrolyte.

17. The electrochemical cell according to claim 9, further comprising the catholyte, the anolyte, and the separator, at least one thereof comprising the boron cluster-based solid state electrolyte.

18. The electrochemical cell according to claim 17, wherein:
the catholyte, the anolyte, and the separator comprise the boron cluster-based solid state electrolyte; and/or
at least one of the catholyte, the anolyte, and the separator comprises another solid state electrolyte that is not a boron cluster-based solid state electrolyte, the another solid state electrolyte selected from the group consisting of a sulfide solid state electrolytes, hydride solid state electrolytes, polymer solid state electrolytes, oxide solid state electrolytes, halide-type solid state electrolytes, plastic crystal solid state electrolytes, inorganic-organic plastic crystal solid state electrolytes, and combinations thereof.

19. The electrochemical cell according to claim 8, wherein the composite salt mixture comprises between 0.30 and 0.50 mole fraction of a halogen-free boron cluster salt, between 0.50 and 0.70 mole fraction of a halogenated boron cluster salt, and an activation energy less than 0.60 eV at one or more temperatures below 30° C.

20. The electrochemical cell according to claim 19, wherein the cationic conductivity of the composite salt mixture is at least two orders of magnitude greater than the cationic conductivity of the halogen-free boron cluster salt and the cationic conductivity of the halogenated boron cluster salt at temperatures below 150° C.
